(19) United States
(12) Patent Application Publication
(10) Pub. No.: US 2008/0304034 A1
(43) Pub. Date: Dec. 11, 2008

(54) DOSE CONTROL FOR OPTICAL MASKLESS LITHOGRAPHY

(75) Inventors: David Christopher Ockwell, Waalre (NL); Johannes Albert Rozenveld, Maarheeze (NL); Minne Cuperus, Veldhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/759,587

(22) Filed: Jun. 7, 2007

(51) Int. Cl. G03B 27/52; G03C 5/04

(52) U.S. Cl. 355/67; 430/396

(57) ABSTRACT

A lithographic apparatus comprises a patterning device, a projection system, and a controller. The patterning device is configured to pattern a beam of radiation. The radiation beam comprises a plurality of pulses of radiation. The projection system is configured to project the patterned beam of radiation onto a substrate coated with a layer of radiation sensitive material. The controller is arranged to control a total energy of a respective pulse of the plurality of pulses of the radiation beam. The controller is configured to take into account information indicative of properties of the layer of radiation sensitive material on a part of the substrate onto which the radiation beam is to be projected.

### BACKGROUND

1. Field of the Invention

The present invention relates to a lithographic apparatus and method, and a method for manufacturing a device.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a mask or a reticle, can be used to generate a circuit pattern corresponding to an individual layer of a flat panel display (or other device). This pattern can be transferred onto all or part of the substrate (e.g., a glass plate), by imaging onto a layer of radiation-sensitive material (e.g., resist) provided on the substrate.

Instead of a circuit pattern, the patterning device can be used to generate other patterns, for example a color filter pattern or a matrix of dots. Instead of a mask, the patterning device can be a patterning array that comprises an array of individually controllable elements. The pattern can be changed more quickly and for less cost in such a system compared to a mask-based system.

When applying a desired pattern onto a substrate or part of a substrate, a thickness of a resist on the substrate can have an effect on the pattern applied to that part of the substrate. For a given thickness of resist, a certain dose of radiation (i.e., the amount of energy to which the part of the substrate is exposed) is required to apply a pattern with desired properties to that part of the resist. For example, that pattern may have a certain desired resolution, e.g., in terms of line thickness or the like. If the thickness of resist increases or decreases across the substrate, the same given dose of radiation will not have the same affect on the resist across the substrate. This means that the line width or other feature size will vary dependent on the location on the substrate. Therefore, if the thickness of resist is not consistent across the substrate, difficulties may be encountered in applying patterns uniformly across the surface of the substrate. Other processing factors may also have an affect on other properties of the resist, thus affecting the ability to apply patterns uniformly across the surface of the substrate.

Therefore, what is needed is a system and method that effectively control dose across a substrate.

### SUMMARY

In one embodiment of the present invention, there is provided a lithographic apparatus comprising one or more arrays of individually controllable elements, a projection system, and a controller. The one or more arrays of individually controllable elements are configured to pattern a beam of radiation. The projection system is configured to project the patterned beam of radiation onto a substrate coated with a layer of radiation sensitive material. The radiation beam comprises a plurality of pulses of radiation. The controller is arranged to control a total energy of a pulse of the radiation beam, the controller being configured to take into account information indicative of properties of the layer of radiation sensitive material on a part of the substrate onto which the radiation beam is to be projected.

In another embodiment of the present invention, there is provided a lithographic method comprising the following steps. Patterning a beam of radiation using one or more arrays of individually controllable elements. Projecting the patterned beam of radiation onto a substrate coated with a layer of radiation sensitive material using a projection system. The radiation beam comprising a plurality of pulses of radiation. Controlling a total energy of a pulse of the radiation beam taking into account information indicative of properties of the layer of radiation sensitive material on a part of the substrate onto which the radiation beam is to be projected.

In a further embodiment of the present invention, there is provided a device manufacturing method comprising the following steps. Patterning a beam of radiation using one or more arrays of individually controllable elements. Projecting the patterned beam of radiation onto a substrate coated with a layer of radiation sensitive material. The radiation beam comprising a plurality of pulses of radiation. Controlling a total energy of a pulse of the radiation beam taking into account information indicative of properties of the layer of radiation sensitive material on a part of the substrate onto which the radiation beam is to be projected.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 depicts a lithographic apparatus.

FIG. 2 depicts a patterning device used to apply a pattern to a resist coated substrate.

FIG. 3 depicts operating principles of the patterning device of FIG. 2.

FIGS. 4a, 4b, 4c, and 4d depict a resist coated substrate and properties of that substrate.

FIG. 5 depicts operating principles.

FIGS. 6a and 6b depict further operating principles.

FIGS. 7a and 7b depict yet further operating principles.

FIGS. 8a and 8b depict alternative operating principles.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment cannot necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

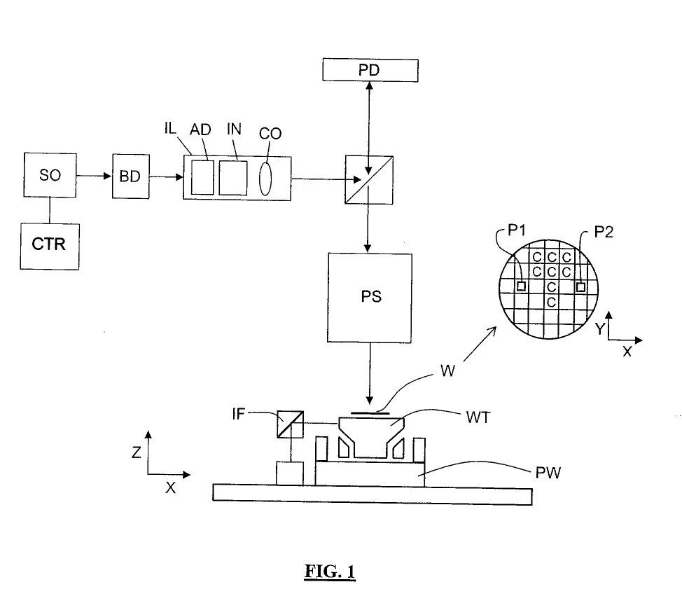

FIG. 1 schematically depicts the lithographic apparatus 1 of one embodiment of the invention. The apparatus comprises an illumination system IL, a patterning device PD, a substrate table WT, and a projection system PS. The illumination system (illuminator) IL is configured to condition a radiation beam B (e.g., UV radiation).

It is to be appreciated that, although the description is directed to lithography, the patterned device PD can be formed in a display system (e.g., in a LCD television or projector), without departing from the scope of the present invention. Thus, the projected patterned beam can be projected onto many different types of objects, e.g., substrates, display devices, etc.

The substrate table WT is constructed to support a substrate (e.g., a resist-coated substrate) W and connected to a positioner PW configured to accurately position the substrate in accordance with certain parameters.

The projection system (e.g., a refractive projection lens system) PS is configured to project the beam of radiation modulated by the array of individually controllable elements onto a target portion C (e.g., comprising one or more dies) of the substrate W. The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein can be considered as synonymous with the more general term “projection system.”

The illumination system can include various types of optical components, such as refractive, reflective, magnetic, electromagnetic, electrostatic or other types of optical components, or any combination thereof, for directing, shaping, or controlling radiation.

The patterning device PD (e.g., a reticle or mask or an array of individually controllable elements) modulates the beam. In general, the position of the array of individually controllable elements will be fixed relative to the projection system PS. However, it can instead be connected to a positioner configured to accurately position the array of individually controllable elements in accordance with certain parameters.

The term “patterning device” or “contrast device” used herein should be broadly interpreted as referring to any device that can be used to modulate the cross-section of a radiation beam, such as to create a pattern in a target portion of the substrate. The devices can be either static patterning devices (e.g., masks or reticles) or dynamic (e.g., arrays of programmable elements) patterning devices. For brevity, most of the description will be in terms of a dynamic patterning device, however it is to be appreciated that a static pattern device can also be used without departing from the scope of the present invention.

It should be noted that the pattern imparted to the radiation beam cannot exactly correspond to the desired pattern in the target portion of the substrate, for example if the pattern includes phase-shifting features or so called assist features. Similarly, the pattern eventually generated on the substrate cannot correspond to the pattern formed at any one instant on the array of individually controllable elements. This can be the case in an arrangement in which the eventual pattern formed on each part of the substrate is built up over a given period of time or a given number of exposures during which the pattern on the array of individually controllable elements and/or the relative position of the substrate changes.

Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such patterning devices include reticles, programmable mirror arrays, laser diode arrays, light emitting diode arrays, grating light valves, and LCD arrays.

Patterning devices whose pattern is programmable with the aid of electronic means (e.g., a computer), such as patterning devices comprising a plurality of programmable elements (e.g., all the devices mentioned in the previous sentence except for the reticle), are collectively referred to herein as “contrast devices.” The patterning device comprises at least 10, at least 100, at least 1,000, at least 10,000, at least 100,000, at least 1,000,000, or at least 10,000,000 programmable elements.

A programmable mirror array can comprise a matrix-addressable surface having a viscoelastic control layer and a reflective surface. The basic principle behind such an apparatus is that addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter can filter out the diffracted light, leaving the undiffracted light to reach the substrate.

An array of diffractive optical MEMS devices (micro-electromechanical system devices) can also be used in a corresponding manner. In one example, a diffractive optical MEMS device is composed of a plurality of reflective ribbons that can be deformed relative to one another to form a grating that reflects incident light as diffracted light.

A further alternative example of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors reflect an incoming radiation beam in a different direction than unaddressed mirrors; in this manner, the reflected beam can be patterned according to the addressing pattern of the matrix-addressable mirrors. The required matrix addressing can be performed using suitable electronic means.

Another example PD is a programmable LCD array.

The lithographic apparatus can comprise one or more contrast devices. For example, it can have a plurality of arrays of individually controllable elements, each controlled independently of each other. In such an arrangement, some or all of the arrays of individually controllable elements can have at least one of a common illumination system (or part of an illumination system), a common support structure for the arrays of individually controllable elements, and/or a common projection system (or part of the projection system).

In one example, such as the embodiment depicted in FIG. 1, the substrate W has a substantially circular shape, optionally with a notch and/or a flattened edge along part of its perimeter. In another example, the substrate has a polygonal shape, e.g., a rectangular shape.

Examples where the substrate has a substantially circular shape include examples where the substrate has a diameter of at least 25 mm, at least 50 mm, at least 75 mm, at least 100 mm, at least 125 mm, at least 150 mm, at least 175 mm, at least 200 mm, at least 250 mm, or at least 300 mm. Alternatively, the substrate has a diameter of at most 500 mm, at most 400 mm, at most 350 mm, at most 300 mm, at most 250 mm, at most 200 mm, at most 150 mm, at most 100 mm, or at most 75 mm.

Examples where the substrate is polygonal, e.g., rectangular, include examples where at least one side, at least 2 sides or at least 3 sides, of the substrate has a length of at least 5 cm, at least 25 cm, at least 50 cm, at least 100 cm, at least 150 cm, at least 200 cm, or at least 250 cm.

At least one side of the substrate has a length of at most 1000 cm, at most 750 cm, at most 500 cm, at most 350 cm, at most 250 cm, at most 150 cm, or at most 75 cm.

In one example, the substrate W is a wafer, for instance a semiconductor wafer. The wafer material can be selected from the group consisting of Si, SiGe, SiGeC, SiC, Ge, GaAs, InP, and InAs. The wafer can be: a III/V compound semiconductor wafer, a silicon wafer, a ceramic substrate, a glass substrate, or a plastic substrate. The substrate can be transparent (for the naked human eye), colored, or absent a color.

The thickness of the substrate can vary and, to an extent, can depend on the substrate material and/or the substrate dimensions. The thickness can be at least 50 μm, at least 100 μm, at least 200 μm, at least 300 μm, at least 400 μm, at least 500 μm, or at least 600 μm. Alternatively, the thickness of the substrate can be at most 5000 μm, at most 3500 μm, at most 2500 μm, at most 1750 μm, at most 1250 μm, at most 1000 μm, at most 800 μm, at most 600 μm, at most 500 μm, at most 400 μm, or at most 300 μm.

The substrate referred to herein can be processed, before or after exposure, in for example a track (a tool that typically applies a layer of resist to a substrate and develops the exposed resist), a metrology tool, and/or an inspection tool. In one example, a resist layer is provided on the substrate.

The projection system can image the pattern on the array of individually controllable elements, such that the pattern is coherently formed on the substrate. Alternatively, the projection system can image secondary sources for which the elements of the array of individually controllable elements act as shutters. In this respect, the projection system can comprise an array of focusing elements such as a micro lens array (known as an MLA) or a Fresnel lens array to form the secondary sources and to image spots onto the substrate. The array of focusing elements (e.g., MLA) comprises at least 10 focus elements, at least 100 focus elements, at least 1,000 focus elements, at least 10,000 focus elements, at least 100,000 focus elements, or at least 1,000,000 focus elements.

The number of individually controllable elements in the patterning device is equal to or greater than the number of focusing elements in the array of focusing elements. One or more (e.g., 1,000 or more, the majority, or each) of the focusing elements in the array of focusing elements can be optically associated with one or more of the individually controllable elements in the array of individually controllable elements, with 2 or more, 3 or more, 5 or more, 10 or more, 20 or more, 25 or more, 35 or more, or 50 or more of the individually controllable elements in the array of individually controllable elements.

The MLA can be movable (e.g., with the use of one or more actuators) at least in the direction to and away from the substrate. Being able to move the MLA to and away from the substrate allows, e.g., for focus adjustment without having to move the substrate.

As herein depicted in FIG. 1, the apparatus is of a reflective type (e.g., employing a reflective array of individually controllable elements). Alternatively, the apparatus can be of a transmission type (e.g., employing a transmission array of individually controllable elements).

The lithographic apparatus can be of a type having two (dual stage) or more substrate tables. In such “multiple stage” machines, the additional tables can be used in parallel, or preparatory steps can be carried out on one or more tables while one or more other tables are being used for exposure.

The lithographic apparatus can also be of a type wherein at least a portion of the substrate can be covered by an “immersion liquid” having a relatively high refractive index, e.g., water, so as to fill a space between the projection system and the substrate. An immersion liquid can also be applied to other spaces in the lithographic apparatus, for example, between the patterning device and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. The radiation source provides radiation having a wavelength of at least 5 nm, at least 10 nm, at least 11-13 nm, at least 50 nm, at least 100 nm, at least 150 nm, at least 175 nm, at least 200 nm, at least 250 nm, at least 275 nm, at least 300 nm, at least 325 nm, at least 350 nm, or at least 360 nm. Alternatively, the radiation provided by radiation source SO has a wavelength of at most 450 nm, at most 425 nm, at most 375 nm, at most 360 nm, at most 325 nm, at most 275 nm, at most 250 nm, at most 225 nm, at most 200 nm, or at most 175 nm. The radiation can have a wavelength including 436 nm, 405 nm, 365 nm, 355 nm, 248 nm, 193 nm, 157 nm, and/or 126 nm.

The source and the lithographic apparatus can be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source can be an integral part of the lithographic apparatus, for example when the source is a mercury lamp. The source SO and the illuminator IL, together with the beam delivery system BD if required, can be referred to as a radiation system.

A controller CTR is provided, and is arranged to control the exposure energy (i.e. dose) of pulses of the radiation beam. The controller CTR may do this by directly controlling the output of the source SO, or in any other appropriate manner, as described below.

The illuminator IL, can comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL can comprise various other components, such as an integrator IN and a condenser CO. The illuminator can be used to condition the radiation beam to have a desired uniformity and intensity distribution in its cross-section. The illuminator IL, or an additional component associated with it, can also be arranged to divide the radiation beam into a plurality of sub-beams that can, for example, each be associated with one or a plurality of the individually controllable elements of the array of individually controllable elements. A two-dimensional diffraction grating can, for example, be used to divide the radiation beam into sub-beams. In the present description, the terms “beam of radiation” and “radiation beam” encompass, but are not limited to, the situation in which the beam is comprised of a plurality of such sub-beams of radiation.

The radiation beam B is incident on the patterning device PD (e.g., an array of individually controllable elements) and is modulated by the patterning device. Having been reflected by the patterning device PD, the radiation beam B passes through the projection system PS, which focuses the beam onto a target portion C of the substrate W. With the aid of the positioner PW and position sensor IF2 (e.g., an interferometric device, linear encoder, capacitive sensor, or the like), the substrate table WT can be moved accurately, e.g., so as to position different target portions C in the path of the radiation beam B. Where used, the positioning means for the array of individually controllable elements can be used to correct accurately the position of the patterning device PD with respect to the path of the beam B, e.g., during a scan.

In one example, movement of the substrate table WT is realized with the aid of a long-stroke module (course positioning) and a short-stroke module (fine positioning), which are not explicitly depicted in FIG. 1. In another example, a short stroke stage cannot be present. A similar system can also be used to position the array of individually controllable elements. It will be appreciated that the beam B can alternatively/additionally be moveable, while the object table and/or the array of individually controllable elements can have a fixed position to provide the required relative movement. Such an arrangement can assist in limiting the size of the apparatus. As a further alternative, which can, e.g., be applicable in the manufacture of flat panel displays, the position of the substrate table WT and the projection system PS can be fixed and the substrate W can be arranged to be moved relative to the substrate table WT. For example, the substrate table WT can be provided with a system for scanning the substrate W across it at a substantially constant velocity.

As shown in FIG. 1, the beam of radiation B can be directed to the patterning device PD by means of a beam splitter BS configured such that the radiation is initially reflected by the beam splitter and directed to the patterning device PD. It should be realized that the beam of radiation B can also be directed at the patterning device without the use of a beam splitter. The beam of radiation can be directed at the patterning device at an angle between 0 and 90°, between 5 and 85°, between 15 and 75°, between 25 and 65°, or between 35 and 55° (the embodiment shown in FIG. 1 is at a 90° angle). The patterning device PD modulates the beam of radiation B and reflects it back to the beam splitter BS which transmits the modulated beam to the projection system PS. It will be appreciated, however, that alternative arrangements can be used to direct the beam of radiation B to the patterning device PD and subsequently to the projection system PS. In particular, an arrangement such as is shown in FIG. 1 cannot be required if a transmission patterning device is used.

The depicted apparatus can be used in several modes:

1. In step mode, the array of individually controllable elements and the substrate are kept essentially stationary, while an entire pattern imparted to the radiation beam is projected onto a target portion C at one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the array of individually controllable elements and the substrate are scanned synchronously while a pattern imparted to the radiation beam is projected onto a target portion C (i.e., a single dynamic exposure). The velocity and direction of the substrate relative to the array of individually controllable elements can be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In pulse mode, the array of individually controllable elements is kept essentially stationary and the entire pattern is projected onto a target portion C of the substrate W using a pulsed radiation source. The substrate table WT is moved with an essentially constant speed such that the beam B is caused to scan a line across the substrate W. The pattern on the array of individually controllable elements is updated as required between pulses of the radiation system and the pulses are timed such that successive target portions C are exposed at the required locations on the substrate W. Consequently, the beam B can scan across the substrate W to expose the complete pattern for a strip of the substrate. The process is repeated until the complete substrate W has been exposed line by line.

4. Continuous scan mode is essentially the same as pulse mode except that the substrate W is scanned relative to the modulated beam of radiation B at a substantially constant speed and the pattern on the array of individually controllable elements is updated as the beam B scans across the substrate W and exposes it. A substantially constant radiation source or a pulsed radiation source, synchronized to the updating of the pattern on the array of individually controllable elements, can be used.

5. In pixel grid imaging mode the pattern formed on substrate W is realized by subsequent exposure of spots formed by a spot generator that are directed onto patterning device PD. The exposed spots have substantially the same shape. On substrate W the spots are printed in substantially a grid. In one example, the spot size is larger than a pitch of a printed pixel grid, but much smaller than the exposure spot grid. By varying intensity of the spots printed, a pattern is realized. In between the exposure flashes the intensity distribution over the spots is varied.

Combinations and/or variations on the above described modes of use or entirely different modes of use can also be employed.

In lithography, a pattern is exposed on a layer of resist on the substrate. The resist is then developed. Subsequently, additional processing steps are performed on the substrate. The effect of these subsequent processing steps on each portion of the substrate depends on the exposure of the resist. In particular, the processes are tuned such that portions of the substrate that receive a radiation dose above a given dose threshold respond differently to portions of the substrate that receive a radiation dose below the dose threshold. For example, in an etching process, areas of the substrate that receive a radiation dose above the threshold are protected from etching by a layer of developed resist. However, in the post-exposure development, the portions of the resist that receive a radiation dose below the threshold are removed and therefore those areas are not protected from etching. Accordingly, a desired pattern can be etched. In particular, the individually controllable elements in the patterning device are set such that the radiation that is transmitted to an area on the substrate within a pattern feature is at a sufficiently high intensity that the area receives a dose of radiation above the dose threshold during the exposure. The remaining areas on the substrate receive a radiation dose below the dose threshold by setting the corresponding individually controllable elements to provide a zero or significantly lower radiation intensity.

In practice, the radiation dose at the edges of a pattern feature does not abruptly change from a given maximum dose to zero dose even if the individually controllable elements are set to provide the maximum radiation intensity on one side of the feature boundary and the minimum radiation intensity on the other side. Instead, due to diffractive effects, the level of the radiation dose drops off across a transition zone. The position of the boundary of the pattern feature ultimately formed by the developed resist is determined by the position at which the received dose drops below the radiation dose threshold. The profile of the drop-off of radiation dose across the transition zone, and hence the precise position of the pattern feature boundary, can be controlled more precisely by setting the individually controllable elements that provide radiation to points on the substrate that are on or near the pattern feature boundary. These can be not only to maximum or minimum intensity levels, but also to intensity levels between the maximum and minimum intensity levels. This is commonly referred to as “grayscaling.”

Grayscaling provides greater control of the position of the pattern feature boundaries than is possible in a lithography system in which the radiation intensity provided to the substrate by a given individually controllable element can only be set to two values (e.g., just a maximum value and a minimum value). At least 3, at least 4 radiation intensity values, at least 8 radiation intensity values, at least 16 radiation intensity values, at least 32 radiation intensity values, at least 64 radiation intensity values, at least 128 radiation intensity values, or at least 256 different radiation intensity values can be projected onto the substrate.

It should be appreciated that grayscaling can be used for additional or alternative purposes to that described above. For example, the processing of the substrate after the exposure can be tuned, such that there are more than two potential responses of regions of the substrate, dependent on received radiation dose level. For example, a portion of the substrate receiving a radiation dose below a first threshold responds in a first manner; a portion of the substrate receiving a radiation dose above the first threshold but below a second threshold responds in a second manner; and a portion of the substrate receiving a radiation dose above the second threshold responds in a third manner. Accordingly, grayscaling can be used to provide a radiation dose profile across the substrate having more than two desired dose levels. The radiation dose profile can have at least 2 desired dose levels, at least 3 desired radiation dose levels, at least 4 desired radiation dose levels, at least 6 desired radiation dose levels or at least 8 desired radiation dose levels.

It should further be appreciated that the radiation dose profile can be controlled by methods other than by merely controlling the intensity of the radiation received at each point on the substrate, as described above. For example, the radiation dose received by each point on the substrate can alternatively or additionally be controlled by controlling the duration of the exposure of the point. As a further example, each point on the substrate can potentially receive radiation in a plurality of successive exposures. The radiation dose received by each point can, therefore, be alternatively or additionally controlled by exposing the point using a selected subset of the plurality of successive exposures.

In order to form the required pattern on the substrate, it is necessary to set each of the individually controllable elements in the patterning device to the requisite state at each stage during the exposure process. Therefore control signals, representing the requisite states, must be transmitted to each of the individually controllable elements. Preferably, the lithographic apparatus includes a controller that generates the control signals. The pattern to be formed on the substrate may be provided to the lithographic apparatus in a vector-defined format such as GDSII. In order to convert the design information into the control signals for each individually controllable element, the controller includes one or more data manipulation devices, each configured to perform a processing step on a data stream that represents the pattern. The data manipulation devices may collectively be referred to as the “datapath”.

The data manipulation devices of the datapath may be configured to perform one or more of the following functions: converting vector-based design information into bitmap pattern data; converting bitmap pattern data into a required radiation dose map (namely a required radiation dose profile across the substrate); converting a required radiation dose map into required radiation intensity values for each individually controllable element; and converting the required radiation intensity values for each individually controllable element into corresponding control signals.

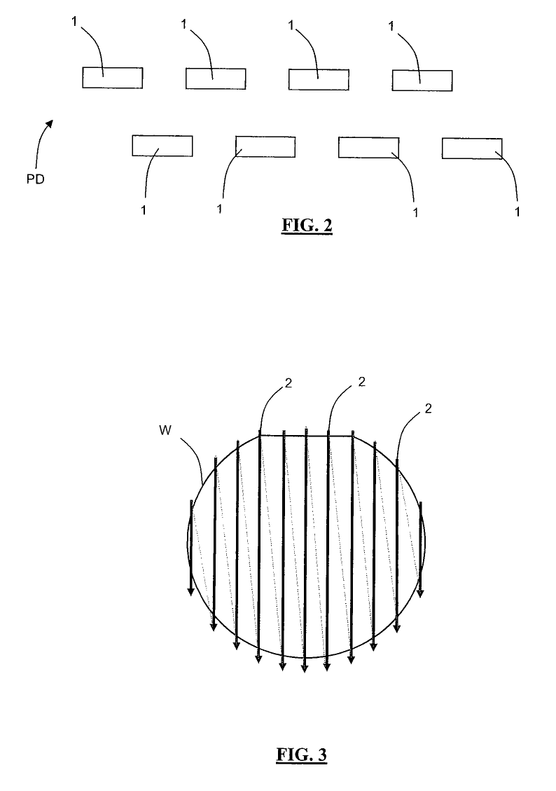

FIG. 2 depicts an exemplary patterning device PD of FIG. 1. The patterning device PD comprises two rows of mirror arrays 1. Each row of mirror arrays 1 comprises four mirror arrays 1 (although it will be appreciated that four mirror arrays 1 is by no means essential, and that more or less mirror arrays may be used). The rows of mirror arrays 1 extend parallel to one another. The mirror arrays 1 are positioned such that the mirror arrays 1 of a first row are positioned opposite spaces between mirror arrays 1 of a second row. Each mirror array 1 is provided with a plurality of individually controllable mirrors (not shown). These mirrors are moveable to impart a pattern into the radiation beam. In use, the substrate is moved relative to the patterning device PD, such that the radiation beam patterned by the patterning device effectively traces out a path across the surface of the substrate. In this way, a pattern may be applied to the surface of the substrate.

FIG. 3 schematically depicts a typical path which the patterned radiation beam may trace out across the substrate W. It can be seen that the substrate W is moved such that the radiation beam traces out a plurality of linear scans 2 across the surface of the substrate W. As the substrate W is moved relative to the patterning device, the configuration of mirrors of the mirror arrays may be changed to change the pattern applied to the substrate. Typically, the radiation beam patterned by the patterning device PD is a pulsed radiation beam. The radiation beam may be made to comprise pulses by pulsing the emission of the source of radiation, or by selectively allowing or preventing passage of the radiation beam (e.g., by using a rotating shutter or the like). The configurations of the mirrors of the mirror arrays are conveniently changed between pulses of the radiation beam. Similarly, between pulses of the radiation beam, the substrate W may be moved relatively to the patterning device PD, so that some or all of the radiation beam is projected onto a different part of the substrate W.

Conventionally, the pulses of the radiation beam have the same integrated energy (i.e., dose). In other words, each pulse projected onto the substrate has the same overall energy. Thus, as the substrate W is moved relative to the patterning device, a series of pulses of the same energy are projected onto the substrate. Also conventionally, radiation beam pulses having the same energy may be applied to the substrate for one or more of a plurality of reasons. One reason is the assumption or approximation that the substrate is evenly coated with a layer of radiation sensitive material (e.g., resist).

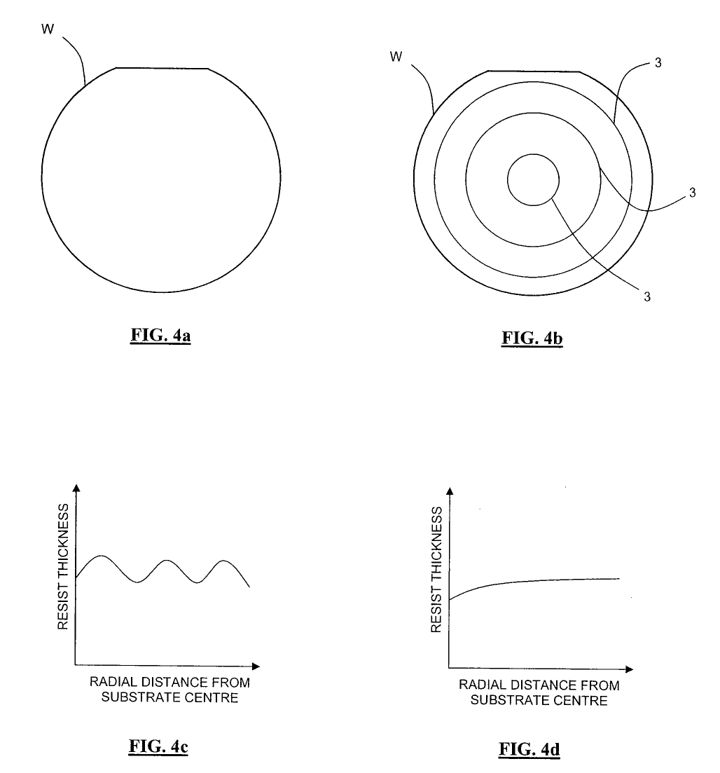

FIG. 4a shows a resist coated substrate W. FIG. 4b shows a contour map of the thickness of resist across the substrate W. It can be seen that there are plurality of contours 3, meaning that the thickness of resist is not uniform across the surface of the substrate W.

FIGS. 4c and 4d illustrate possible profiles for the thickness of the resist as measured from the center of the substrate outwards in a radial direction. It will however be appreciated that these profiles are examples, and are not limiting, and that other thickness profiles are possible.

The thickness of resist may vary across the substrate for any number of reasons. For example, resist is normally applied to a substrate using a spin-coating process. During the spin-coating process, the viscosity of the resist may be affected by different extents across the substrate. As a consequence of the change in viscosity, the resist may dry at different rates across the substrate. In drying at different rates, the resist may form a layer of varying thickness across the substrate.

Conventionally, a pulsed radiation beam having pulses of equal overall energy are used to apply a pattern to a resist coated substrate in the assumption that the resist is of a uniform thickness across the substrate.

In FIGS. 4a to 4d, it has been demonstrated that a resist coated substrate will not always be evenly coated with resist.

Using conventional methods and apparatus, therefore, each part of the substrate will be exposed to pulses of the radiation beam having equal total energy, regardless of the thickness of the resist (i.e., the pulses will have the same intensity and duration). Since the resist is of a different thickness across the substrate, this means that the pattern applied to different parts of the resist may vary according to its thickness. This is because the pattern applied to a resist coated substrate is not only dependent on the dose of radiation to which a part of the resist is exposed, but also upon the thickness of the part of the resist that is exposed.

According to one or more embodiments of the present invention, if the thickness of the resist is taken into account when projecting the pulsed radiation beam onto the resist coated substrate, the total energy of pulses of the radiation beam pulses can be varied for different parts of the substrate to take into account the thickness of the resist (i.e., the total integrated energy of a pulse of a radiation beam can be varied, for example by varying the pulse intensity and/or duration). This means that patterns can be more uniformly applied to all areas of the substrate regardless of the thickness of the resist.

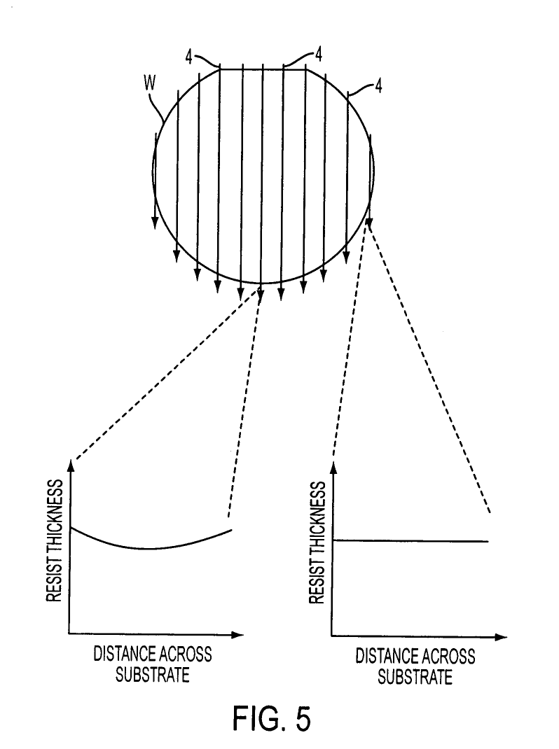

FIG. 5 shows how the thickness of the resist across the substrate W may be measured. The thickness of the resist across the substrate W is measured in the same direction in which the radiation beam is scanned or moved across the substrate surface. That is, a series of linear profiles 4 of how the thickness of resist varies across the substrate can be determined, one profile for each scan of the radiation beam across the substrate. It can be seen from FIG. 5 that the thickness of resist across a given part of the substrate W may vary depending on which part of the substrate W the thickness profile is taken across. For example, it can be seen that in regions extending across the periphery of the substrate W, the thickness of resist may not vary very much at all. On the other hand, across the centre of the substrate W, the thickness of the resist may vary by as much as 0.5%-10%. Therefore, in order to ensure that a pattern is uniformly applied to different parts of the substrate, the pulses of the radiation beam need to have a higher total energy where the resist thickness is highest, and a default or lower energy where the resist thickness is lower.

Although FIG. 5 illustrates a plurality of resist thickness profiles being taken from the top to the bottom of the substrate (as it appears in FIG. 5), this is not essential. For example, a linear resist profile can be taken from the top to the bottom of the substrate, followed by the taking of a linear resist profile from the bottom to the top of the substrate (e.g., the profile can be taken in an up-down-up-down, etc. fashion). The direction or directions in which the linear profiles are taken can mirror the direction or directions in which the substrate is moved during exposures. For example, the substrate can be moved such that the radiation beam only ever moves across the surface of the substrate in a single direction, or such that the radiation beams moves across the surface of the substrate in an up-down-up-down, etc. fashion.

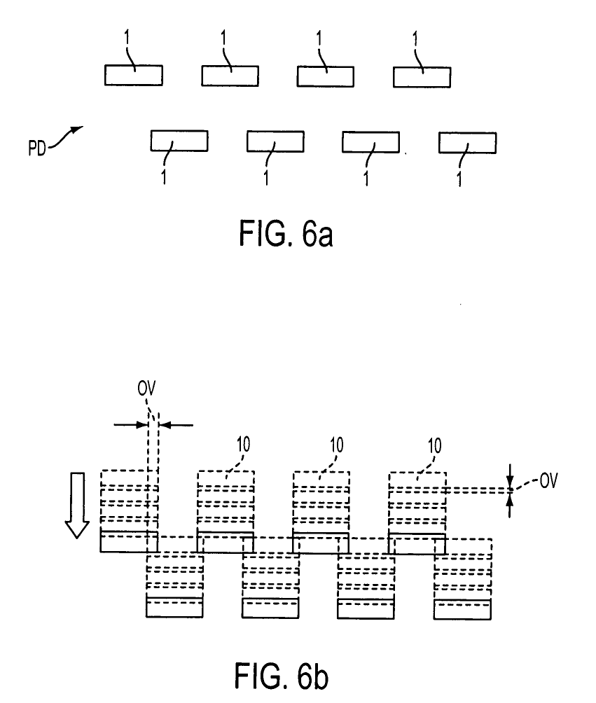

FIG. 6a shows a patterning device PD used to apply a pattern to a resist coated substrate W. The patterning device PD comprises two rows of mirror arrays 1, each mirror array 1 comprising an array of individually controllable mirrors (not shown). These mirrors are moveable to impart a pattern into the radiation beam. Each mirror array 1 is approximately 41.6 mm long by 16.8 mm wide. The rows of mirror arrays 1 extend parallel to one another, and are separated by a distance of around 80 mm. The mirror arrays 1 of a first row are positioned opposite spaces between mirror arrays 1 of a second row, but with some overlap of their lengths (e.g., footprints) when projected onto one another (as will be described in more detail below).

Although FIG. 6a shows that each row of mirror arrays 1 comprises four mirror arrays 1, any suitable number of mirror arrays 1 may be used in each row. More than two rows may be used. In some lithographic apparatuses, each row of mirror arrays 1 comprises seven mirror arrays.

FIG. 6b depicts use of the patterning device PD of FIG. 6a. FIG. 6b shows a succession of footprints 10 of the mirror arrays 1 as the substrate is moved to allow the pulsed radiation beam to be projected onto different parts of the substrate. At the level of the substrate, the footprints 10 of the mirror arrays are four hundred times smaller than the physical size of the mirror arrays 1 themselves (i.e., a reduction factor is introduced). That is, the footprint of each mirror array 1 at the substrate level is about 104 μm×42 μm, each row of mirror arrays being separated by about 200 μm. The footprints 10 of the mirror arrays 1 are much smaller than the physical size of the mirror arrays 1 themselves so that high resolution patterning may be undertaken. Various optical elements maybe used (e.g., lenses or mirrors or a combination of the two) to introduce the reduction factor. In other embodiments, reduction factors great or less than four hundred may be used. For example a reduction factor of two hundred and sixty seven may be employed.

For a first pulse of the radiation beam, the substrate is in a first position. For a second pulse of the radiation beam, the substrate has been moved to a second position, and so on. The substrate is moved in a linear fashion, such that the footprint 10 of the mirror arrays 1 move across the surface of the substrate in a stepwise manner, in tandem with the pulses of the radiation beam. As the substrate is moved relative to the patterning device, the total energy of the pulses of the radiation beam may be controlled by a controller (e.g., the controller CTR of FIG. 1), which takes into account the thickness of the resist onto which the radiation beam is to be projected. For example, if the region of resist onto which the pulsed radiation beam is to be projected is getting thicker, the intensity or duration of the pulses of the radiation beam can be increased. Conversely, if the thickness of the resist is decreasing, the intensity or duration of the pulse can be reduced.

It can be seen from FIG. 6b that there is some overlap OV between the footprints 10 of the mirror arrays. This is to avoid any gaps or lines being present between the patterns projected by the mirror arrays onto the substrate. Where the footprints 10 overlap, a process known as “stitching” must be undertaken, whereby the intensity of radiation projected onto a substrate by each mirror array must decrease at its edges. This is so that the intensity of the overlapping parts of the footprints 10 does not exceed the intensity of radiation projected onto other non-overlapping parts of the footprints 10. The intensity of radiation reflected onto the substrate by the mirrors at or near the edges of the mirror arrays may be reduced by appropriate control of the position or orientation of those mirrors.

Because the intensity of radiation forming parts of the overlapping footprints 10 should not exceed that of the intensity of radiation projected onto non-overlapping parts of the footprints 10, the total energy of the pulses of the radiation beam can only be increased/decreased in small steps. For example, the total energy of the individual pulses used may not be allowed to exceed certain limits across certain parts of the substrate. For example, the change in the total energy of the pulses may not be able to exceed about 0.1%, 0.5%, 1.0%, 2.0% or 3.0% within or across sections (e.g., dies, overlapping footprints) on the substrate. This can be ensured by increasing/decreasing the total energy of the pulses in small steps up to a maximum of about 0.1%, 0.5%, 1.0%, 2.0% or 3.0% change of the default total energy in a given section. It will be appreciated that due to the dimensions of the mirror arrays, and the separation of the mirror array rows, the footprints of mirror arrays in a first row will overlap with the footprints of mirror arrays in a second row after sufficient movement of the substrate (i.e., the mirror arrays are 40 μm in length in the direction of movement of the substrate and the rows are separated by about 200 μm, meaning that five steps or incremental movements of the substrate will cause the footprints 10 to overlap). The maximum change in energy of the pulses over this range of movement may not exceed a certain level, for example about a 0.1%, 0.5%, 1.0%, 2.0% or 3.0% change of the default total energy, so that the resist under the overlapping footprints is exposed to no more than a about 0.1%, 0.5%, 1.0%, 2.0% or 3.0% change in total energy (i.e., dose). A typical pulse of radiation beam may have a total energy in the range of about 5 mJ to 90 mJ, and more particularly about 5 mJ to 30 mJ.

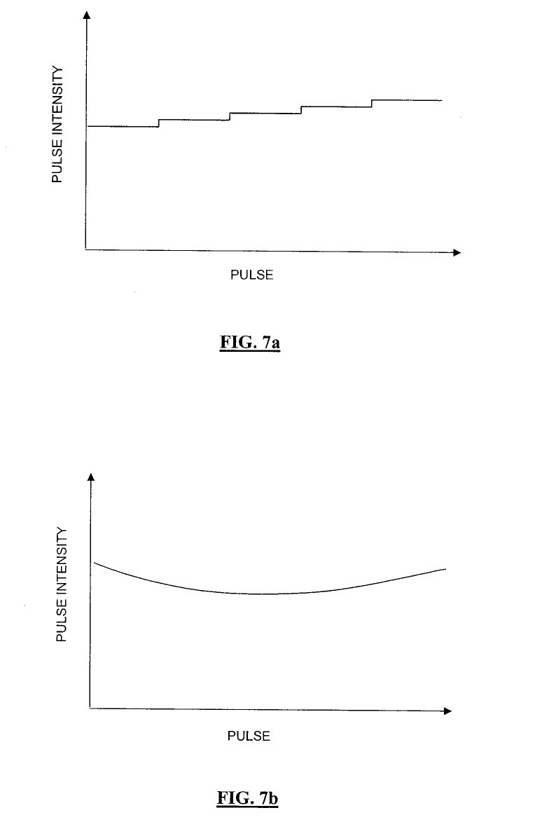

FIG. 7a shows how the total energy of the pulses of the radiation beam may be varied by slowly increasing their intensity as, for example, the thickness of the resist increases across the substrate.

FIG. 7b shows how the intensity profile of the pulses of the radiation beam may vary across the entire length of a section of a substrate.

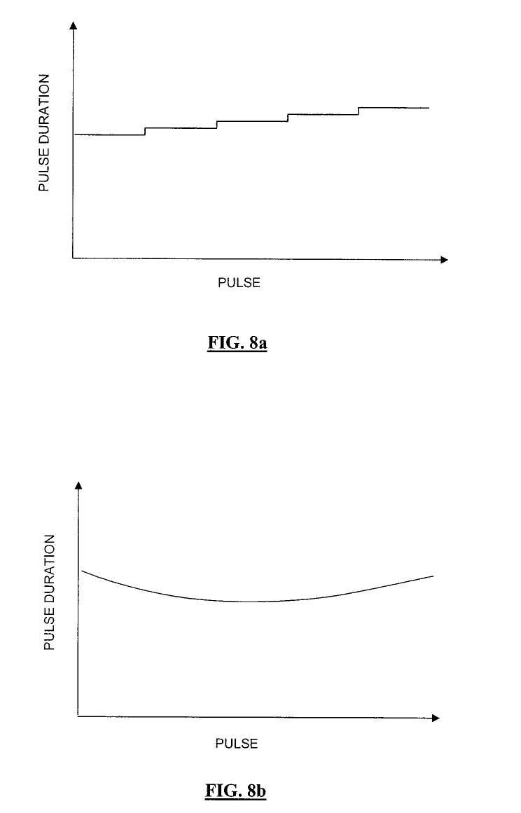

FIG. 8a shows how, instead of varying the intensity of the pulses of the radiation beam, the duration of the pulses of the radiation beam may be altered to affect the total energy of the pulses. It can be seen that the duration of the pulses is slowly increased to increase the energy of each pulse, as for example, the thickness of the resist increases.

FIG. 8b shows how the profile of the duration of the pulses of the radiation beam may vary across the length of a section of a substrate.

As described above, the total energy of the pulses of the radiation beam can be controlled by varying the intensity of the radiation beam's pulses, or the duration of the pulses. The controller CTR of FIG. 1 may control the emission intensity and/or pulse duration of the source directly. Alternatively, the controller CTR may indirectly control the intensity and/or duration of pulses of the radiation beam. For example, the controller CTR may control an apparatus in the path of the radiation beam. Such apparatus may include filters or switches (e.g., electro-optical switches), which can control the intensity or duration of the pulses of the radiation beam. The choice of whether the intensity and/or duration of pulses of the radiation beam are controlled directly (e.g., by controlling the source) or indirectly (e.g., by using switches) may depend on the time over which changes in the intensity and/or duration of pulses are required. For instance, it may well take longer to change the emission intensity of a source, than it would to control a switch. The controller CTR may be provided with information indicative of the thickness of resist to control the pulse energies, or may store such information. The information may not be actual resist thicknesses, but may be a factor by which to reduce or increase the intensity and/or duration of the radiation beam. The information may be data, or may be control voltages or the like. The controller CTR may be, for example, a computational device or the like, or an electrical circuit or a part thereof.

In the description of FIG. 5, it was mentioned that a series of linear resist thickness profiles 4 were taken. A controller CTR was then used to take into account these profiles 4 and to vary the total energy of pulses applied to the resist coated substrate. The determination of the thickness of the resist may be undertaken in any known manner. For example, the thickness can be measured using optical or mechanical techniques known in the art. The thickness of the resist may be measured on the substrate onto which a pattern is to be projected. Alternatively, the thickness of resist of an identically processed substrate may be measured, and those thicknesses used to vary the energy of radiation pulses applied to another substrate. In lithography, the processing techniques used are consistent and reliable enough to be able to use a substrate as a reference for obtaining resist thicknesses, and to then use these resist references thicknesses to vary the intensity and/or duration of pulses of radiation applied to other identically processed substrates. It will be appreciated that a plurality of linear resist profiles is not essential. Resist thicknesses can be measured in any appropriate manner to establish a map (or the like) of how the resist thickness varies across the substrate.

In one or more of the above embodiments, the total energy of pulses of a radiation beam has been controlled to take into account variations in the thickness of resist across a substrate. Although the variation in resist thickness is one of the main contributors in substrate process uniformity, other factors also have an effect. The total energy of pulses of the radiation beam may be controlled to take into account these other factors which affect properties of the resist. For example, the resist thickness may be uniform across the substrate, but processing conditions (e.g., drying of the resist, post spin-coating baking of the substrate, etc.) may affect the sensitivity of the resist to the radiation beam. Thus, in general, the controller may control the total energy of pulses of the radiation beam to take into account the sensitivity of the resist to the radiation beam as a function of position across the substrate. As with the determination of resist thickness mentioned above, the general sensitivity of the resist to the radiation beam may be determined in any number of ways. For example, a substrate coated with resist could be exposed to a radiation beam, and the resulting patterns formed on the resist could be analyzed to determine how sensitive the resist was (e.g., by determining the width of lines, or the size of other features in an exposed pattern). This information may be obtained from patterns applied to a reference substrate, or to other previously patterned substrates. This information, which is indicative of the sensitivity of the resist, can then be used by the controller to control the total energy of pulses of a radiation beam projected onto further substrates to ensure that the patterns applied are more uniform. Properties of the resist, or information indicative of properties of the resist, can be obtained by an analysis of the critical dimension uniformity (CDU) of patterns applied to the substrate, or an identically processed substrate used a reference substrate. For example, the widths of pattern lines or other features can be used to determine the thickness of the resist, since the thickness of the resist will determine just how wide those lines (or other features) are for a given dose of exposure radiation.

Other properties of the resist may be taken into account by the controller when controlling the total energy of the pulses of the radiation beam. Such properties, as examples and not as limitations, may include: (1) the type of resist applied to the substrate (e.g., different types of resist will have different consequent responses to other pre-exposure and post-exposure conditions); (2) the process conditions during the application of the resist to the substrate (e.g., the thermal profile during the application process that may include a soft bake process, etc.); (3) the corresponding process conditions during the application of any other layer applied to the substrate (e.g., a BARC (Bottom Anti Reflection Coating) that may be applied before the resist to reduce the generation of standing waves in the resist to improve imaging conditions and CDU performance); (4) the time elapsed between the resist being applied to the substrate and an exposure, which, due to the relatively long time taken to expose a substrate using a lithographic apparatus using an array of individually controllable elements, may have a significant impact on the threshold dosage for the resist; this may change significantly from the portion first exposed on a substrate to the last portion exposed on a substrate; (5) the elapsed time between the resist being applied to the substrate and the commencement of the post exposure processing steps (e.g., this will affect the response of the exposed resist when it is developed); (6) the time elapsed or the expected time elapsed between any other two processes; (7) the process conditions of the post-exposure bake, including the thermal profile; again this will affect the response of the exposed resist when it is developed; (8) the process conditions of chilling the substrate after the post-exposure bake, again including the thermal profile which will also affect the response of the exposed substrate when it is developed; (9) the process conditions during the developing of the substrate; (10) the conditions during transport of the substrate between the various processing apparatus; and/or (11) the expected process conditions in subsequent etching, ion implantation, metallization, oxidation, chemo-mechanical polishing and cleaning processes.

In the patterning device described above, a plurality of mirror arrays is employed. However, this is not essential. In some embodiments, only a single array of individually controllable elements may be required.

In general, when a plurality of arrays of individually controllable elements is used, a pulse of radiation is incident to all of the arrays simultaneously. That is, any variation of the pulse energy will be applied to all of the arrays, and thus their footprints on the substrate. The thicknesses of the resist across the substrate vary relatively slowly. This means that even though the footprints of the plurality arrays are spread across an area of the substrate, the area is so small that any resist thickness variation is negligible across that area. The variation in resist thickness only becomes practically tangible across multiple steps of the radiation beam across the substrate, which means that the small variations in the pulse energy across one or more steps is an acceptable way of accounting for the variation in resist thicknesses across the substrate.

It will be appreciated that some parts of the substrate may be exposed to radiation on several occasions (e.g., a plurality of pulses of the radiation beam), for example during repeated scans of the substrate relative to the radiation beam. If this is the case, each pulse of radiation may not comprise the total energy (i.e., dose) needed to satisfactorily apply a pattern to the resist. Instead, each pulse of radiation will comprise a fraction of the total energy needed to satisfactorily apply a pattern to the resist. The total energy of the plurality of pulses, and thus the fractional energy of each pulse of the plurality, will be controlled by the controller to take into account the sensitivity of the resist as a function of position across the substrate.

Although specific reference can be made in this text to the use of lithographic apparatus in the manufacture of a specific device (e.g., an integrated circuit or a flat panel display), it should be understood that the lithographic apparatus described herein can have other applications. Applications include, but are not limited to, the manufacture of integrated circuits, integrated optical systems, guidance and detection patterns for magnetic domain memories, flat-panel displays, liquid-crystal displays (LCDs), thin-film magnetic heads, micro-electromechanical devices (MEMS), light emitting diodes (LEDs), etc. Also, for instance in a flat panel display, the present apparatus can be used to assist in the creation of a variety of layers, e.g., a thin film transistor layer and/or a color filter layer.

Although specific reference is made above to the use of embodiments of the invention in the context of optical lithography, it will be appreciated that the invention can be used in other applications, for example imprint lithography, where the context allows, and is not limited to optical lithography. In imprint lithography a topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

1. A lithographic apparatus, comprising:
a patterning device configured to pattern a beam of radiation, the radiation beam comprising a plurality of pulses of radiation;
a projection system configured to project the patterned beam of radiation onto a substrate coated with a layer of radiation sensitive material; and
a controller arranged to control a total energy of a respective pulse in one of the plurality of pulses of the radiation beam, the controller being configured to take into account information indicative a property of the layer of radiation sensitive material on a part of the substrate onto which the radiation beam is to be projected.

2. The lithographic apparatus of claim 1, wherein the controller is configured to control the total energy of the respective pulse without changing a configuration of the patterning device.

3. The lithographic apparatus of claim 1, wherein the controller is configured to take into account information indicative of the thickness of the layer of radiation sensitive material on the part of the substrate onto which the radiation beam is to be projected.

4. The lithographic apparatus of claim 1, wherein the controller is arranged to control the total energy of the respective pulse by controlling an intensity of the respective pulse.

5. The lithographic apparatus of claim 1, wherein the controller is arranged to control the total energy of the respective pulse by controlling a duration of the respective pulse.

6. The lithographic apparatus of claim 1, wherein the controller is arranged to control the total energy of the respective pulse by controlling a source of the radiation beam.

7. The lithographic apparatus of claim 1, wherein the controller is arranged to control the total energy of the respective pulse by controlling an apparatus in a beam path of the radiation beam.

8. The lithographic apparatus of claim 1, wherein the patterning device comprises a plurality of arrays of individually controllable elements.

9. The lithographic apparatus of claim 8, wherein the plurality of arrays of individually controllable elements are arranged in a row.

10. The lithographic apparatus of claim 8, wherein the plurality of arrays of individually controllable elements are arranged in two rows.

11. The lithographic apparatus of claim 10, wherein the two rows are parallel to one another and spaced apart from one another.

12. The lithographic apparatus of claim 11, wherein the arrays of individually controllable elements of a first row are aligned with spaces in-between arrays of a second row.

13. The lithographic apparatus of claim 12, wherein the arrays of individually controllable elements of the first row are positioned such that their footprints overlap with those of the arrays of individually controllable elements of the second row, such that the radiation beam may be projected onto different parts of the substrate.

14. The lithographic apparatus of claim 13, wherein the controller is arranged to control the total energy of the plurality of pulses of the radiation beam, such that the difference in energy between respective ones of the plurality of pulses applied to the layer of radiation sensitive material beneath overlapping footprints is below about 0.1%, 0.5%, 1.0%, 2.0%, or 3.0%.

15. The lithographic apparatus of claim 1, wherein the substrate is configured to move relative to the patterning device.

16. The lithographic apparatus of claim 1, wherein the substrate is moveable relative to the patterning device.

17. The lithographic apparatus of claim 1, wherein the patterning device comprises an array of individually controllable elements, which comprise mirror arrays.

18. The lithographic apparatus of claim 1, wherein the controller is arranged to receive information indicative of the properties of the layer of radiation sensitive material.

19. The lithographic apparatus of claim 1, wherein the controller is arranged to store information indicative of the properties of the layer of radiation sensitive material.

20. The lithographic apparatus of claim 1, wherein the radiation sensitive material is photo resist.

21. The lithographic apparatus of claim 1, wherein the controller is arranged to control the total energy of the plurality of pulses of the radiation beam.

22. The lithographic apparatus of claim 1, wherein the controller is arranged to individually control the total energy of each pulse of the plurality of pulses of the radiation beam.

23. A lithographic method, comprising:
patterning a beam of radiation, the radiation beam comprising a plurality of pulses of radiation, using a patterning device;
projecting the patterned beam of radiation onto a substrate including a radiation sensitive material thereon; and
controlling a total energy of a respective pulse in the plurality of pulses of the radiation beam taking into account information indicative of properties of the radiation sensitive material on a part of the substrate onto which the radiation beam is to be projected.

24. The lithographic method of claim 23, wherein the total energy of the respective pulse is controlled without changing a configuration of the patterning device.

25. The lithographic method of claim 23, wherein the information indicative of properties of the radiation sensitive material comprises information indicative of a thickness of the radiation sensitive material on the part of the substrate onto which the radiation beam is to be projected.

26. The lithographic method of claim 23, wherein the information indicative of the properties of the radiation sensitive material on the part of the substrate onto which the radiation beam is to be projected is obtained from a reference substrate.

27. The lithographic method of claim 23, wherein information indicative of properties of the radiation sensitive material across a surface of the substrate onto which the radiation beam is to be projected is obtained from a reference substrate.

28. The lithographic method of claim 23, wherein the information indicative of the properties of the radiation sensitive material on the part of the substrate onto which the radiation beam is to be projected is obtained from determining a plurality of linear profiles of resist properties across a reference substrate.

29. The lithographic method of claim 26, wherein the information indicative of the properties of the radiation sensitive material is obtained from the reference substrate before any radiation is projected onto the substrate onto which radiation is to be projected.

30. The lithographic method of claim 23, wherein the information indicative of the properties of the radiation sensitive material on the part of the substrate onto which the radiation beam is to be projected is obtained from an analysis of critical dimension uniformity of a pattern or patterns applied to a reference substrate.

31. A device manufacturing method, comprising:
patterning a beam of radiation using a patterning device, the radiation beam comprising a plurality of pulses of radiation;
projecting the patterned beam of radiation onto a substrate including radiation sensitive material thereon; and
controlling a total energy of a pulse of the radiation beam taking into account information indicative of properties of the radiation sensitive material on a part of the substrate onto which the radiation beam is to be projected.
